(19) United States
(12) Patent Application Publication
(10) Pub. No.: US 2017/0122107 A1
(43) Pub. Date: May 4, 2017

(54) TURBINE ROTOR FOR A LOW PRESSURE TURBINE OF A GAS TURBINE SYSTEM

(71) Applicant: MTU Aero Engines AG, Munich (DE)

(72) Inventor: Patrick WACKERS, Munich (DE)

(21) Appl. No.: 15/333,592

(22) Filed: Oct. 25, 2016

(30) Foreign Application Priority Data
Oct. 30, 2015 (DE) 102015221324.2.0

(51) Int. Cl. F01D 5/06; F01D 25/00; F02C 7/36; F01D 5/08

(52) U.S. Cl. CPC F01D 5/06; F01D 5/087; F01D 25/005; F02C 7/36; F05D 2220/323; F05D 2230/25; F05D 2240/24; F05D 2300/175

(57) ABSTRACT

The invention relates to a turbine rotor for a low pressure turbine of a gas turbine system, in particular of an aero engine, comprising four bladed rotor disks which are arranged in series in the flow direction, wherein at least two of the rotor disks consist at least in part of a nickel-based superalloy which has the following chemical composition: Fe 4%, Co 8.5%, Cr 15.7%, Mo 3.1%, W 2.7%, Al 2.25%, Ti 3.4%, Nb 1.1%, B 0.01%, C 0.015%, Zr 0.03% and remainder Ni. The invention further relates to a low pressure turbine for a gas turbine system, and to a gas turbine system.

### CROSS-REFERENCE TO RELATED APPLICATIONS

The present application claims priority under 35 U.S.C. §119 of German Patent Application No. 102015221324.2, filed Oct. 30, 2015, the entire disclosure of which is expressly incorporated by reference herein.

### BACKGROUND OF THE INVENTION

1. Field of the Invention

The invention relates to a turbine rotor for a low pressure turbine of a gas turbine system, which has at least one bladed rotor disk. The invention further relates to a low pressure turbine having such a turbine rotor, and to a gas turbine system having such a low pressure turbine.

2. Discussion of Background Information

Modern gas turbine systems require, in order to comply with the stipulated specifications, low pressure turbines with high AN², high turbine inlet temperatures and compact, short constructions, in order to permit high cycle efficiency and reduced fuel consumption. Thus, low pressure turbines are among the highly loaded components in a gas turbine system such as an aero engine, and must withstand high rotational speeds and temperature fluctuations.

It would therefore be advantageous to have available a turbine rotor for a low pressure turbine which permits the production of compact low pressure turbines with high efficiency and low production costs. It would also be advantageous to have available a corresponding low pressure turbine and a gas turbine system having such a low pressure turbine.

### SUMMARY OF THE INVENTION

The present invention provides a turbine rotor, a low pressure turbine, a gas turbine system and the use as indicated in the independent claims. Advantageous embodiments with expedient refinements of the invention are indicated in the respective dependent claims, wherein advantageous embodiments of each invention aspect are to be regarded as advantageous embodiments of the respective other invention aspects, and vice versa.

A first aspect of the invention relates to a turbine rotor for a low pressure turbine of a gas turbine system, which comprises four bladed rotor disks which are arranged in series in the flow direction, wherein at least two of the rotor disks (14a-c) consist at least in part of the nickel-based superalloy AD730. In other words, it is provided that the turbine rotor is of four-stage design, or comprises four rotor disks, whose rotor blades accordingly form four turbine blade rows and which are arranged axially in series with respect to an axis of rotation of the turbine rotor. This permits greater energy extraction from the process gas, making it possible to further increase the cycle efficiency. Using four bladed rotor blades achieves an optimal compromise between the construction space requirement of the turbine rotor the efficiency increase that can be achieved due to the greater energy extraction from the process gas. In that context, it is provided that at least two of the rotor disks consist partially or entirely of AD730. It is however alternatively also possible for three all of the rotor disks to respectively consist partially or entirely of AD730. The nickel-based superalloy AD730 was developed by the company Aubert & Duval and has the following chemical composition (in weight-%, based on the total weight of the alloy):

| | |
|---|---|
| Fe | 4% |
| Co | 8.5% |
| Cr | 15.7% |
| Mo | 3.1% |
| W | 2.7% |
| Al | 2.25% |
| Ti | 3.4% |
| Nb | 1.1% |
| B | 0.01% |
| C | 0.015% |
| Zr | 0.03% |

remainder Ni

As recognized by the inventors, the use of AD730 for the at least partial production of at least two rotor disks of a four-stage turbine rotor permits on one hand an advantageous improvement in the mechanical and thermal properties of the rotor disk with, at the same time, reduced costs. As is also the case for other nickel-based superalloys, AD730 possesses, on account of its microstructure, advantageous mechanical strength at high temperatures. In comparison to other nickel-based superalloys, however, AD730 surprisingly offers a better combination of various high-temperature properties at temperatures above 700° C., with at the same time lower costs in comparison to other wrought and cast superalloys. The mechanical properties of AD730 are fundamentally close to those of Udimet720, but are markedly better than for example 718Plus, Waspaloy and 718. In contrast for example to superalloys such as Waspaloy and Udimet720, however, AD730 is more easily worked. In particular, AD730 is simpler to form, and easier to forge below and/or above the gamma-prime solvus temperature. Furthermore, AD730 possesses an advantageous combination of strength, creep and fatigue properties at temperatures of 700° C. or above and has particularly great structure stability to temperatures greater than 750° C. Thus, the use of AD730 permits the production of rotor disks which on one hand can withstand particularly high temperatures and rotational speeds, and on the other hand can be produced more simply and with lower use of material and thus particularly compact league and with relatively low weight. Furthermore, the turbine rotor according to the invention permits an advantageous saving in terms of seal air, for example of 0.2% or more. Thus, what is provided is a turbine rotor for a low pressure turbine, with the aid of which a reheat cycle with higher efficiency and higher energy output is possible, whereby the fuel consumption of the associated low pressure turbine, or of an associated gas turbine system, is accordingly reduced. The blades of the rotor disk usually consist of a different material, it being in principle also possible to provide that the blades connected to the rotor disk consist at least in part of AD730.

In a context, it has been found to be advantageous, in one embodiment of the invention, if at least one of the rotor disks consists entirely of the nickel-based superalloy AD730, since this makes it possible for the above-mentioned advantages to be realized to a correspondingly high degree.

In another embodiment, it has been shown to be advantageous if the first three rotor disks, as seen in the flow direction, consist of the nickel-based superalloy AD730 and the fourth rotor disk, as seen in the flow direction, consists of a different alloy. In other words, it is provided that, of the four rotor disks, only the three rotor disks which, in the installed state, are oriented toward the inlet of the associated low pressure turbine respectively consist partially or entirely of AD730. Since the turbine inlet temperature is highest in this region, the first three rotor disks, as seen in the flow direction, or their rotor blades, are subject to the greatest loads, and hence the use of AD730 is particularly advantageous since particularly high process gas temperatures can be generated in the region of the first three turbine stages. Higher temperatures mean more work output and, as the case may be, permit a higher cycle efficiency. The fourth rotor disk, oriented toward an outlet of the associated low pressure turbine, is by contrast exposed to relatively lower temperatures and pressures by virtue of the preceding energy extraction by the rotor blades of the three upstream rotor disks, such that for this disk a different alloy, possibly having less high-temperature strength, can be used. This embodiment is particularly well-suited to uncooled low pressure turbines.

Alternatively, it has been found to be advantageous if the middle two rotor disks consist of the nickel-based superalloy AD730 and the first and fourth rotor disks, as seen in the flow direction, consist of a different alloy. This embodiment is particularly well-suited to cooled low pressure turbines since by charging the first bladed rotor disk, which is to be arranged on the inlet side, with a coolant such as air, lower thermal loading of the first turbine stage can be achieved. Hence, it is sufficient to manufacture only the second and third rotor disks, as seen in the flow direction, respectively partially or entirely of AD730, while the downstream, or fourth, rotor disk consists of a different material.

In another advantageous embodiment of the invention, it is provided that the third rotor disk, as seen in the flow direction, can be and/or is connected to a turbine shaft. In other words, it is provided that the four-stage turbine rotor can be and/or is connected to a turbine shaft via the third rotor disk, as seen in the flow direction. The bladed rotor disks of the first, second and fourth stages can be borne by the third stage.

A second aspect of the invention relates to a low pressure turbine for a gas turbine system, in particular for an aero engine, comprising a turbine rotor and a reduction gearing by means of which the turbine rotor can be connected to a fan and/or a compressor stage, wherein the turbine rotor is designed in accordance with the first invention aspect.

With the aid of the reduction gearing, the fan with its large diameter, or the compressor stage, can rotate more slowly and the low pressure turbine can rotate substantially faster, such that it can also be termed a high-speed low pressure turbine. Thus, both components can achieve their respective optimum during operation and also help the geared fan to achieve a very high efficiency. This permits a substantial reduction in fuel consumption and an associated reduction in CO₂ emissions. In that context, it can in principle be provided that the reduction gearing is used to effect a blower arrangement or fan arrangement that rotates with or counter to the turbine rotor of the low pressure turbine, in order to support increasing fuel efficiency. Together with the turbine rotor according to the invention, the low pressure turbine can be of particularly compact design and has high efficiency with relatively low production costs. Further features and their advantages emerge from the description of the first invention aspect, wherein advantageous embodiments of the first invention aspect are to be regarded as advantageous embodiments of the second invention aspect, and vice versa.

In one advantageous implement of the invention, it is provided that the low pressure turbine comprises at least one flow duct through which coolant can be conveyed to the turbine rotor. This can be used to permit cooling, in particular of a rotor disk arranged on the inlet side and of the rotor blades borne thereby, such that in this region it is possible to use for example materials that are less heat resistant than AD730. The coolant can for example be routed through internal cooling geometries of stator vanes and/or rotor blades, and exit at their trailing edge regions.

A third aspect of the invention relates to a gas turbine system, in particular an aero engine, comprising a low pressure turbine in accordance with the second invention aspect, wherein the turbine rotor of the low pressure turbine is connected via the reduction gearing to a fan and/or a compressor stage of the gas turbine system. The features, and their advantages, resulting herefrom can be found in the descriptions of the second invention aspect, wherein advantageous embodiments of the first and second invention aspect are to be regarded as advantageous embodiments of the third invention aspect, and vice versa.

A fourth aspect of the invention relates to the use of the nickel-based superalloy AD730 for the at least partial production of at least two rotor disks of a four-stage turbine rotor for a low pressure turbine of a gas turbine system. The features, and their advantages, resulting herefrom can be found in the descriptions of the first, second and third invention aspect, wherein advantageous embodiments of the first, second and third invention aspect are to be regarded as advantageous embodiments of the fourth invention aspect, and vice versa.

Further features of the invention emerge from the claims and the exemplary embodiments. The features and feature combinations mentioned above in the description, as well as the features and feature combinations mentioned and/or indicated alone in the exemplary embodiments below, can be used not only in the combination specified in each case, but also in other combinations or in isolation, without departing from the scope of the invention. Thus, embodiments of the invention which are not explicitly indicated and explained in the exemplary embodiments, but result from and can be produced using separate feature combinations from the explained embodiments, are also to be regarded as included and disclosed. Also to be regarded as disclosed are embodiments and feature combinations which therefore do not have all of the features of an originally formulated independent claim.

### BRIEF DESCRIPTION OF THE DRAWINGS

In the drawings:

FIG. 1 shows a schematic, lateral section view of a low pressure turbine according to a first exemplary embodiment; and

FIG. 2 shows a schematic, lateral section view of a low pressure turbine according to a second exemplary embodiment.

### DETAILED DESCRIPTION OF EMBODIMENTS OF THE INVENTION

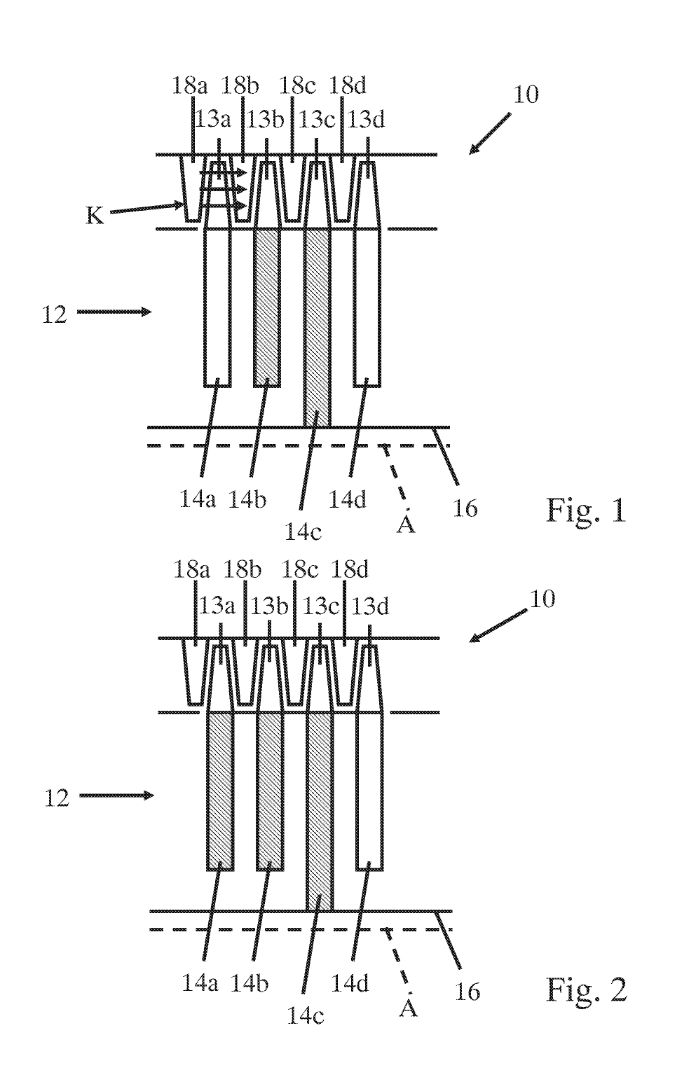

FIG. 1 shows a schematic, lateral section view of an upper part of a low pressure turbine 10 (LPT) according to a first exemplary embodiment. In the exemplary embodiment shown, the low pressure turbine 10 is designed as a cooled, high-speed low pressure turbine 10 and part of a gas turbine system (not shown). The low pressure turbine 10 comprises a four-stage turbine rotor 12 which accordingly comprises four bladed rotor disks 14a-d which are arranged axially with respect to an axis of rotation A of the turbine rotor 12, or in series as seen in the flow direction. The rotor blades of the bladed rotor disks 14a-d are provided with the reference signs 13a-d. In that context, the two middle rotor disks 14b, 14c consist entirely of the nickel-based superalloy AD730 (represented by hatching), while the inlet-side rotor disk 14a and the outlet-side rotor disk 14d consist of a different alloy. This is possible because coolant can be supplied to the turbine rotor 12 via a flow duct (not shown), such that it is possible to use, for the rotor disk 14a, materials that are less heat-resistant than AD730. In that context, the arrows provided with the reference sign “K” symbolize trailing edge discharge from stator vanes 18a and rotor blades 13a of the first rotor disk 14a, after the coolant has passed through the respective internal geometry. Accordingly, it is also possible for the fourth rotor disk 14d to consist of a less heat-resistant material since the rotor blades 13a-c of the upstream rotor disks 14a-c, as seen in the flow direction, already extract energy from the process gas during operation. The turbine rotor 12 is connected, via the third rotor disk 14c, as seen in the flow direction, to a turbine shaft 16 and drives, via a reduction gearing (not shown) a fan of the gas turbine system. The third rotor disk 14c, connected to the turbine shaft 16, there's the three other bladed rotor disks 14a, 14b and 14d. Alternating with the rotor blades 13a-d are provided, in a manner known per se, four rows or rings of stator vanes 18a-d, by means of which the incident flow on the rotor blades 13a-d is influenced.

FIG. 2 shows a schematic, lateral section view of the low pressure turbine 10 according to a second exemplary embodiment. In contrast to the preceding exemplary embodiment, the low pressure turbine 10 is designed as an uncooled, high-speed low pressure turbine 10 which accordingly comprises no flow duct, and no internal cooling geometries for supplying coolant.

Similarly to the first exemplary embodiment, the low pressure turbine 10 also comprises a four-stage turbine rotor 12 which accordingly comprises four rotor disks 14a-d which are provided with rotor blades 13a-d and which are arranged axially with respect to an axis of rotation A of the turbine rotor 12, or in series as seen in the flow direction. In the present exemplary embodiment, however, not only the middle rotor disks 14b, 14c but also the inlet-side rotor disk 14a consist entirely of the nickel-based superalloy AD730 in order to allow for the relatively high inlet temperatures of the process gas. The outlet-side rotor disk 14d consists, by analogy with the first exemplary embodiment, of a different alloy since the rotor blades 13a-c of the upstream rotor disks 14a-c, as seen in the flow direction, already extract energy from the process gas during operation. The rest of the construction of the low pressure turbine 10 corresponds to that of the first exemplary embodiment.

### LIST OF REFERENCE NUMERALS

10 Low pressure turbine
12 Turbine rotor
13a-d Rotor blades
14a-d Rotor disk
16 Turbine shaft
18a-d Stator vanes
A Axis of rotation
K Coolant

1.-9. (canceled)

10. A turbine rotor for a low pressure turbine of a gas turbine system, wherein the rotor comprises four bladed rotor disks which are arranged in series in the flow direction, at least two of the rotor disks consisting at least in part of a nickel-based superalloy having the following chemical composition:

| | |
|---|---|
| Fe | 4%, |
| Co | 8.5%, |
| Cr | 15.7%, |
| Mo | 3.1%, |
| W | 2.7%, |
| Al | 2.25%, |
| Ti | 3.4%, |
| Nb | 1.1%, |
| B | 0.01%, |
| C | 0.015%, |
| Zr | 0.03% and |

remainder Ni.

11. The turbine rotor of claim 10, wherein the gas turbine system is an aero engine.

12. The turbine rotor of claim 10, wherein at least one of the rotor disks consists entirely of the nickel-based superalloy.

13. The turbine rotor of claim 10, wherein at least two of the rotor disks consist entirely of the nickel-based superalloy.

14. The turbine rotor of claim 10, wherein the first three rotor disks, as seen in flow direction, consist of the nickel-based superalloy and the fourth rotor disk, as seen in flow direction, consists of a different alloy.

15. The turbine rotor of claim 14, wherein the gas turbine system is an aero engine.

16. The turbine rotor of claim 10, wherein the middle two rotor disks consist of the nickel-based superalloy and the first and fourth rotor disks, as seen in flow direction, consist of a different alloy.

17. The turbine rotor of claim 16, wherein the gas turbine system is an aero engine.

18. The turbine rotor of claim 10, wherein the third rotor disk, as seen in flow direction, can be and/or is connected to a turbine shaft.

19. The turbine rotor of claim 14, wherein the third rotor disk, as seen in flow direction, can be and/or is connected to a turbine shaft.

20. The turbine rotor of claim 16, wherein the third rotor disk, as seen in flow direction, can be and/or is connected to a turbine shaft.

21. A low pressure turbine for a gas turbine system, wherein the turbine comprises the turbine rotor of claim 10 and a reduction gearing by which the turbine rotor can be connected to a fan and/or a compressor stage.

22. The low pressure turbine of claim 21, wherein the turbine comprises at least one flow duct through which coolant can be conveyed to the turbine rotor.

23. A gas turbine system, wherein the system comprises the low pressure turbine of claim 21 and wherein the turbine rotor of the low pressure turbine is connected via a reduction gearing to a fan and/or a compressor stage of the gas turbine system.

24. The gas turbine system of claim 23, wherein the gas turbine system is an aero engine.

25. A method for the at least partial production of at least two rotor disks of a four-stage turbine rotor for a low pressure turbine of a gas turbine system, wherein the method comprises producing the at least two rotor disks using a nickel-based superalloy having the following chemical composition:

| | |
|---|---|
| Fe | 4%, |
| Co | 8.5%, |
| Cr | 15.7%, |
| Mo | 3.1%, |
| W | 2.7%, |
| Al | 2.25%, |
| Ti | 3.4%, |
| Nb | 1.1%, |
| B | 0.01%, |
| C | 0.015%, |
| Zr | 0.03% and |

remainder Ni.

26. The method of claim 25, wherein the first three rotor disks, as seen in flow direction, are made of the nickel-based superalloy and the fourth rotor disk, as seen in flow direction, is made of a different alloy.

27. The method of claim 26, wherein the gas turbine system is an aero engine.

28. The method of claim 25, wherein the middle two rotor disks are made of the nickel-based superalloy and the first and fourth rotor disks, as seen in flow direction, are made of a different alloy.

29. The method of claim 28, wherein the gas turbine system is an aero engine.
